(19) United States
(12) Patent Application Publication
(10) Pub. No.: US 2015/0308173 A1
(43) Pub. Date: Oct. 29, 2015

(54) Sliding Door Intermediate Trolley Tensioner Apparatus, Systems and Methods of Making and Using the Same

(71) Applicant: Propel Doors LLC, Chatham, IL (US)

(72) Inventor: Mark Lawrence Gazda, Springfield, IL (US)

(21) Appl. No.: 14/698,433

(22) Filed: Apr. 28, 2015

Related U.S. Application Data
(60) Provisional application No. 61/984,991, filed on Apr. 28, 2014.

(51) Int. Cl. E05D 15/06; E06B 3/46

(52) U.S. Cl. CPC E05D 15/0643; E06B 3/4636; E05D 15/0621; E05D 15/0652

(57) ABSTRACT

The present invention relates to a tensioner apparatus for an intermediate trolley on a sliding door. Specifically, the tensioner apparatus allows control of weight distribution among a plurality of trolleys for a sliding door, such as a pole barn door. The tensioner apparatus comprises a threaded rod extending from a sliding door trolley at a first end thereof, and further having a nut and a plate on the second end thereof, and a spring extending between the plate and a sliding door beam disposed on an upper portion of the sliding door. Tightening or loosening of the nut on the threaded rod allows a user to increase or decrease, respectively, the load of the sliding door carried by the trolley. Methods of making and using the same are further provided.

The present invention claims priority to U.S. Provisional Pat. App. No. 61/984,991, titled “Sliding Door Intermediate Trolley Tensioner Apparatus, Systems and Methods of Making and Using the Same”, filed Apr. 28, 2014, which is incorporated by reference herein in its entirety.

### TECHNICAL FIELD

The present invention relates to a tensioner apparatus for an intermediate trolley on a sliding door. Specifically, the tensioner apparatus allows control of weight distribution among a plurality of trolleys for a sliding door, such as a pole barn door. The tensioner apparatus comprises a threaded rod extending from a sliding door trolley at a first end thereof, and further having a nut and a plate on the second end thereof, and a spring extending between the plate and a sliding door beam disposed on an upper portion of the sliding door. Tightening or loosening of the nut on the threaded rod allows a user to increase or decrease, respectively, the load of the sliding door carried by the trolley. Methods of making and using the same are further provided.

### BACKGROUND

Sliding doors are well-known for covering entrances. Specifically, barns and storage sheds may have relatively large openings to allow heavy machinery, such as tractors and the like, to enter and exit the barns or sheds. The openings may have a sliding door panel disposed over the opening to open and shut. The sliding door panel may be mounted to at least one trolley running on a track above the sliding door panel for moving the sliding door open or shut over the opening. The door panel may hang from the at least one trolley.

In most cases, a first trolley on one end of the door panel and a second trolley on a second end of the door panel (so-called “outer trolleys”) traverse a track and allow for easy opening and closing of the door panel. FIG. 1 illustrates a prior art sliding pole barn door 1 having a trolley track 2, a first outer trolley 3 and a second outer trolley 4. The trolleys 3,4 bear the entire weight of the sliding door, with the trolleys rolling within the trolley track 2.

Close-up views of prior art trolleys are illustrated in FIG. 2. These trolleys typically have a plurality of wheels 5a, 5b rollably disposed within a track and attached to a frame 6, with a threaded rod 7 descending from the frame 6 and attached to a bracket 8. The bracket 8 is typically bolted to a sliding door. A nut 9 may be attached to the frame 6 for adjusting the threaded rod 7 to raise and/or lower the threaded rod 7 and, thus, the sliding door.

However, trolleys on sliding doors are only rated to hold so much weight, so larger doors may require intermediate trolleys placed between the two outer trolleys to bear some of the weight of the door panels. Specifically, if a trolley bears more weight than the trolley is rated, then damage may be done to the trolley and/or the door panel, as well as any equipment or living creatures near the door panel if the door panel fell.

An intermediate trolley may have a bolt descending therefrom to bolt to a top beam on a door panel. A nut beneath the beam of the door panel may be tightened or loosened to allow the intermediate door panel to bear more or less, respectively, of the weight of the door. For example, if a door panel weight 600 pounds, first and second outer trolleys would roughly bear 300 pounds each, without an intermediate trolley. If the outer trolleys were rated to bear only 200 pounds each, then at least one intermediate trolley may be desired to be utilized to bear some of the weight of the door as it hangs. It may be desired that a single intermediate trolley bear 200 pounds of weight of the door panel, while the outer trolleys also bear 200 pounds of weight each, thereby ensuring that the trolleys are not over-stressed. Tightening of the nut on the threaded rod descending from the frames of the trolleys increases or decreases the load on the intermediate trolley relative to the outer trolleys.

However, it is often difficult to specifically determine how much weight the intermediate trolleys bear when the nut is tightened or loosened. Clearly, it is important to know whether the intermediate trolley or trolleys bear sufficient weight to decrease the load on the outer trolleys. In addition, it is important to know whether the intermediate trolley or trolleys do not bear too much weight where the intermediate trolley or trolleys may be damaged. A need, therefore, exists for an apparatus for allowing trolleys on a sliding door panel to be adjusted to bear more or less weight of the sliding door panel. Specifically, a need exists for an apparatus for allowing an intermediate trolley to easily bear a desired amount of door panel weight to relieve stress on other trolleys.

More specifically, a need exists for an apparatus that allows a user to determine how much weight an intermediate trolley bears. Moreover, a need exists for an apparatus that provides a visual indicator to a user of the amount of weight an intermediate trolley bears.

Moreover, a need exists for an apparatus that may be easily adjusted by a user to allow an intermediate trolley to bear a desired amount of door panel weight. Further, a need exists for an apparatus that may be accessible to adjust at any time the load on an intermediate trolley.

### SUMMARY OF THE INVENTION

The present invention relates to a tensioner apparatus for an intermediate trolley on a sliding door. Specifically, the tensioner apparatus allows control of weight distribution among a plurality of trolleys for a sliding door, such as a pole barn door. The tensioner apparatus comprises a threaded rod extending from a sliding door trolley at a first end thereof, and further having a nut and a plate on the second end thereof, and a spring extending between the plate and a sliding door beam disposed on an upper portion of the sliding door. Tightening or loosening of the nut on the threaded rod allows a user to increase or decrease, respectively, the load of the sliding door carried by the trolley. Methods of making and using the same are further provided.

To this end, in an embodiment of the present invention, an adjustable trolley system is provided. The adjustable trolley system comprises an intermediate sliding door trolley having wheels, a frame, and a threaded rod descending from the frame, wherein the threaded rod travels through an upper surface of a sliding door and extends a distance beneath the upper surface of the sliding door; the trolley further having an adjustable nut disposed on the bottom end of the threaded rod, and a spring between the nut and the upper surface of the sliding door, wherein adjusting the nut up or down increases or decreases, respectively, the weight of the sliding door borne by the trolley relative to outer trolleys attached to the sliding door.

It is, therefore, an advantage and objective of the present invention to provide an apparatus for allowing trolleys on a sliding door panel to be adjusted to bear more or less weight of the sliding door panel.

Specifically, it is an advantage and objective of the present invention to provide an apparatus for allowing an intermediate trolley to easily bear a desired amount of door panel weight to relieve stress on other trolleys.

More specifically, it is an advantage and objective of the present invention to provide an apparatus that allows a user to determine how much weight an intermediate trolley bears.

Moreover, it is an advantage and objective of the present invention to provide an apparatus that provides a visual indicator to a user of the amount of weight an intermediate trolley bears.

Further, it is an advantage and objective of the present invention to provide an apparatus that may be easily adjusted by a user to allow an intermediate trolley to bear a desired amount of door panel weight.

Still further, it is an advantage and objective of the present invention to provide an apparatus that may be accessible to adjust at any time the load on an intermediate trolley.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a front view of a prior art sliding door having two outer trolleys supporting the sliding door and rolling within a track.

FIG. 2 illustrates two close-up views of a prior art trolley.

FIG. 3 illustrates a perspective view of an adjustable tensioner for an intermediate trolley in an embodiment of the present invention.

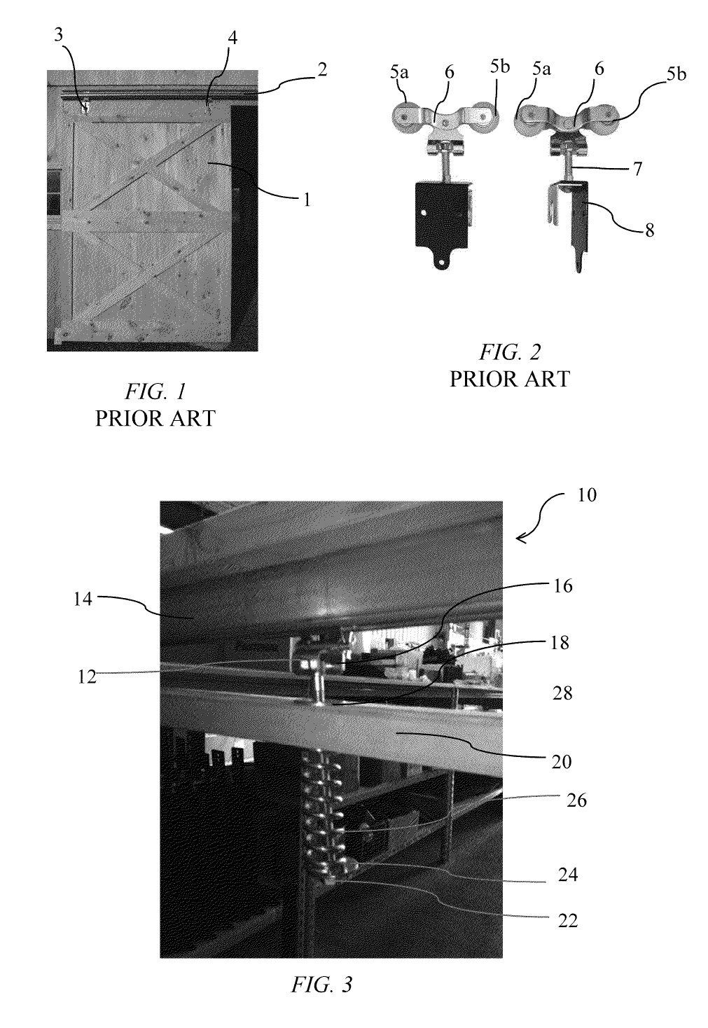

### DETAILED DESCRIPTION OF THE PRESENTLY PREFERRED EMBODIMENTS

The present invention relates to a tensioner apparatus for an intermediate trolley on a sliding door. Specifically, the tensioner apparatus allows control of weight distribution among a plurality of trolleys for a sliding door, such as a pole barn door. The tensioner apparatus comprises a threaded rod extending from a sliding door trolley at a first end thereof, and further having a nut and a plate on the second end thereof, and a spring extending between the plate and a sliding door beam disposed on an upper portion of the sliding door. Tightening or loosening of the nut on the threaded rod allows a user to increase or decrease, respectively, the load of the sliding door carried by the trolley. Methods of making and using the same are further provided.

Now referring to the figures, wherein like numerals refer to like parts, FIG. 3 illustrates a perspective view of an adjustable trolley system 10 in an embodiment of the present invention. The trolley system 10 may comprise a trolley 12 slidably or rollably disposed within a track 14. The trolley 12 may further have a frame 16 and a threaded rod 18 descending from the frame 16 and extending through a beam 20. The threaded rod 18 may be relatively long to extend a distance below the beam 20.

The beam 20 may represent the top of a sliding door that may be attached to the trolley 12 for sliding within the track 14. FIG. 3 illustrates the beam 20 without the remainder of the sliding door for purposes of illustration so that the threaded rod 18 and other components disclosed below may be viewable. Preferably, the sliding door of the present invention may be a sliding pole barn door, although the trolley system 10 may be utilized with any sliding door system, and should not be limited as described herein. Typically, the threaded rod 18 may be disposed within the sliding door, and may be accessible by a user thereof, as necessary to adjust as described below.

The threaded rod 18 may descend beneath the beam 20 and may further have a nut 22 disposed on an end thereof. A washer or plate 24 may be disposed on top of the nut, and a resilient spring 26 may be disposed above the washer or plate 24, extending between the washer or plate 24 to the underside of the beam 20 or to another surface. One or more additional washers or plates, such as washer or plate 28 may be disposed at various locations to provide a surface for attachment of various components or to block the spring 26. Specifically, in an embodiment of the present invention, the spring 26 may be disposed between washer or plate 24 and washer or plate 28.

Preferably, the trolley 12 is an intermediate trolley on a sliding door. The trolley system 10, described herein, may be utilized to adjust the effective load borne by the intermediate trolley. Specifically, a sliding pole barn door may typically have a first outer trolley and a second outer trolley that, without any intermediate trolleys, may bear the entirety of the weight of the door between them. One or more intermediate trolleys may be utilized to bear some of the weight of the door and decrease the amount of weight borne by the outer trolleys.

Adjustment of the nut 22 up or down allows the trolley 12 to bear more or less, respectively, of the weight of the sliding door relative to the outer trolleys. For example, to increase the weight of the door borne by the intermediate trolley 12, the nut 22 may be adjusted upwardly, thereby tensioning the spring 26 and effectively moving the beam 20 upwardly toward the trolley track 14. This adjustment of the beam upwardly may cause the trolley 12 to bear more of the weight of the door relative to the outer trolleys. Likewise, adjusting the nut 22 downwardly may effectively decrease the weight of the door borne by the trolley 12 relative to the outer trolleys.

A mark or a plurality of marks may be viewable on the threaded rod 18 so that an individual adjusting the nut 22 may see how much weight the trolley 12 bears. For example, in an embodiment of the present invention, it may be determined that the movement of the beam 20 a half inch relative to the threaded rod upwardly may effective increase the weight borne by the trolley 12 by 100 pounds. Thus, if it is desired that the intermediate trolley 12 should bear 300 pounds of the sliding door, removing 300 pounds of the sliding door borne by the outer trolleys, the nut may be adjusted to raise the beam 20 upwardly by 1 ¼ inches. Of course, it should be noted that the spring 26 may be any size, with any spring constant and should not be limited as described herein, and the precise amount of movement of the beam relative to the threaded rod 18 may be determined, as apparent to one of ordinary skill in the art.

To utilize the trolley system 10 of the present invention, the sliding door may be attached to the trolley 10, as shown in FIG. 3. The nut 22 may be adjusted upwardly so that the spring 26 just begins to compress. This may be utilized as the starting point of adjusting the trolley system 10 of the present invention, and at this point, the trolley system 12 bears approximately no weight of the door, or a minimal amount of weight of the door. A mark may be made on the threaded rod, or if a plurality of marks is already present on the threaded rod, a visual indicator may be gleaned by the user thereof. The desired weight of the door to be borne by the outer trolleys and the intermediate trolley may be previously calculated. The nut 22 may be adjusted to compress the spring 26 and effectively raise the beam 20 relative to the outer trolleys, increasing the effective weight borne by the intermediate trolley 12 until the desired weight is reached, based on the distance that the beam 20 or another element moves relative to the initial mark made on the threaded rod 18.

Likewise, in another embodiment of the present invention, a sliding door may have a plurality of intermediate trolleys, each composed of the trolley system 10, described herein. Each of these trolleys may be adjusted as described herein to bear an amount of weight of the sliding door, as desired. The intermediate trolleys, thus, may be coordinated to bear respectrive loads, and each may require successive adjustments to arrive at the amount of weight desired to be borne by the plurality of intermediate trolleys.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. An adjustable trolley system comprising:
an intermediate sliding door trolley having wheels, a frame, and a threaded rod descending from the frame, wherein the threaded rod travels through an upper surface of a sliding door and extends a distance beneath the upper surface of the sliding door;
the trolley further having an adjustable nut disposed on the bottom end of the threaded rod, and a spring between the nut and the upper surface of the sliding door, wherein adjusting the nut up or down increases or decreases, respectively, the weight of the sliding door borne by the trolley relative to outer trolleys attached to the sliding door.
